(19) United States
(12) Patent Application Publication
(10) Pub. No.: US 2015/0081593 A1
(43) Pub. Date: Mar. 19, 2015

(54) Method for Deriving Insights by Categorizing Companies Based on Net Sales and Net Profits

(71) Applicant: Impetus Infotech India Pvt. Ltd., Bangalore (IN)

(72) Inventors: Yajuvender Singh, Noida (IN); Sunil Patni, Indore (IN); Vinayak Modi, Indore (IN); Chandak Raghav, Indore (IN)

(21) Appl. No.: 14/485,048

(22) Filed: Sep. 12, 2014

(30) Foreign Application Priority Data
Sep. 14, 2013 (IN) 1148/CHE/2013

(51) Int. Cl. G06Q 40/06; G06T 11/20

(52) U.S. Cl. CPC G06Q 40/06; G06T 11/206
USPC 705/36 R

(57) ABSTRACT

The present invention relates to an investment decision making system for providing investment insights. The investment decision making system of the present invention comprises a database server for storing the data essential for providing investment insights, an end user for querying the investment decision system for deriving insights for any entity for a particular period inputted by the end user. The system also comprises a processor configured to determine a net profit change (ΔP) and a net sales change (ΔS) for the queried entity from the data stored in the database server and to allocate the queried entity to any one of the quadrant based on the relative movement of the net profit change (ΔP) and the net sales change (ΔS).

The following specification particularly describes the invention and the manner in which it is to be performed:

### TECHNICAL FIELD OF THE INVENTION

The present invention relates to a system and method for deriving insight by categorizing companies based on net sales and net profits.

### BACKGROUND OF THE INVENTION

Investors commonly perform investment analysis before taking any investment decisions. Most of the investors take the aid of investment decision making systems for taking such investment decisions. But the current investment decision making systems are based on assumptions and forecast of future business models. Also, the current investment decision making systems emphasize on drilling data to various levels/sublevels and the results generated are open to multiple interpretations. Thus, the current investment decision making systems promote formation of an expertise coterie for application of such decision making systems.

For instance, the US patent application no 20010892578 (referred herein as ‘578’) assigned to BROWN STEVEN discloses a system and method for providing information services. The system as disclosed in ‘578’ plots the queried entity on a XY axis, wherein x-axis is a measurement of share of industry in reverse order and y-axis is a measure of “growth” (or decline) verses year-ago. But the system does not provide insights such as relative performance of an entity in the same quadrant, if there are multiple entities in the same quadrant. Also the system does not provide other insights such as movement of an entity across the quadrants thereby enabling the investor to reach a conclusive investment decision in a smaller time frame.

Hence there exists a need of a system and method that simplifies and eliminates extensive drill-down of data to reach a conclusive investment decision in smaller time frame.

### SUMMARY OF THE INVENTION

The present invention overcomes the drawbacks of the prior art by providing a system and method for deriving investment insights. The investment decision making system of the present invention categorizes entities in four different quadrants based on change in net sales and net profit for the queried entity for a particular period inputted by the end user. For this purpose, the investment decision making system of the present invention comprises a database server for storing the data essential for providing investment insights, an end user for querying the investment decision system for deriving insights for any entity for a particular period inputted by the end user.

The investment decision making system of the present invention also comprises a processor configured to determine a net profit change (ΔP) and a net sales change (ΔS) for the queried entity from the data stored in the database server and to allocate the queried entity to any one of the quadrant based on the relative movement of net profit change (ΔP) and the net sales change (ΔS) for a particular period inputted by the end user. The investment decision making system of the present invention also provides other insights for enabling the end user to take investment decision such as an upstream movement, a downstream movement, an entry and exit of the queried entity along the quadrants for a particular period inputted by the end user.

In accordance to one embodiment of the present invention, the investment decision making system also provides on demand graphical view of the entities depicted in the quadrants using different shapes, different sizes and different colors.

In accordance to one embodiment of the present invention, the method for providing investment insights comprises the steps of storing the data essential for providing investment insights and receiving the query from the end user for taking investment decisions on a particular entity for a particular period. On receiving the query the method determines the net profit and net sales for the queried entity and allocates the queried entity to any one of the quadrants based on net profit change (ΔP) and net sales change (ΔS). The method of the present invention also provides other insights such as an upstream movement and a downstream movement of the queried entity for a particular period inputted by the end user. The method of the present invention provides the entry and exit of the queried entity from one quadrant to another quadrant for a particular period inputted by the end user and also determines the longevity of the performance of the queried entity in a particular quadrant for a particular period inputted by the end user.

Thus, the system and method of the present invention provide a quadrant view of the queried entities along with upstream movement, downstream movement, entry, entry and longevity of the performance of the queried entity along the quadrants for a particular period inputted by the end user, thereby eliminating extensive drill-down of data to reach a conclusive investment decision in a smaller time frame.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates an investment decision making system in detail in accordance to one or more embodiment of the present invention.

FIG. 2 and FIG. 3 illustrate a quadrant categorization functionality of the investment decision making system in accordance to one or more embodiment of the present invention.

FIG. 4 illustrates an upstream and downstream movement of an entity in any one of the quadrant in accordance to one or more embodiment of the present invention.

FIG. 5 illustrates the entry and exit of an entity in any one of the quadrant in accordance to one or more embodiment of the present invention.

FIG. 6 illustrates an exemplary quadrant view of the investment decision making system in detail in accordance to one or more embodiment of the present invention.

FIG. 6a illustrates an exemplary graphical view of the entities in accordance to one or more embodiment of the present invention.

FIG. 6b illustrates a graphical representation of the movement of an entity from one quadrant to another quadrant in accordance to one embodiment of the present invention.

FIG. 6c illustrates a graphical representation of the movement of an entity from one quadrant to another quadrant in accordance to another embodiment of the present invention.

FIG. 6d illustrates a master view of the entities in accordance to one or more embodiment of the present invention.

FIG. 7a and FIG. 7b illustrate a process flow of the method for providing investment insights in accordance to one or more embodiment of the present invention.

FIG. 7c and FIG. 7d illustrate a process flow of the method for allocating the queried entity to any one of the quadrants based on net profit change (ΔP) and net sales change (ΔS).

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

The term ‘entity’ used herein refers to any company, industry, business group or a capitalization segment.

The term ‘end user’ used herein represents any investor, analyst, financial advisor, retail advisor or a financial researcher.

The present invention relates to an investment decision making system for providing investment insights. The investment decision making system of the present invention comprises a database server for storing the data essential for providing investment insights, an end user for querying the investment decision system for deriving insights for any entity for a particular period inputted by the end user. The system also comprises a processor configured to determine a net profit change (ΔP) and a net sales change (ΔS) for the queried entity from the data stored in the database server and to allocate the queried entity to any one of the quadrant based on the relative movement of the net profit change (ΔP) and the net sales change (ΔS).

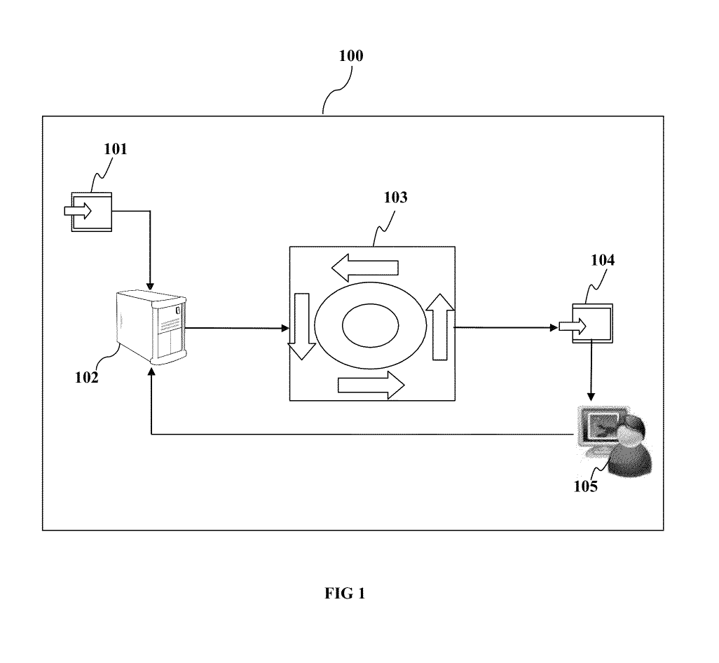

FIG. 1 illustrates an investment decision making system in detail in accordance to one or more embodiment of the present invention. The investment decision making system (100) of the present invention comprises a database server (102) for storing the data (101) essential for providing investment insights and is updated regularly on a real time basis. Here, the data (101) comprises financial data of entities such as net sales, net profit of entities on a periodic basis. When the end user (105) queries the investment decision system (100) for any industry or a business group or a capitalization segment for a period say, on a quarterly basis or a yearly basis, the processor (103) of the investment decision making system (100) is configured to determine a net profit change (ΔP) and a net sales change (ΔS) for the queried entity from the data stored in the database server (102) and to allocate the queried entity to any one of the quadrant (200a, 200b, 200c and 200d) based on net profit change (ΔP) and net sales change (ΔS). The investment decision making system (100) provides quadrant view (104) of the queried entity along with other insights such as a upstream movement, a downstream movement of the queried entities along the quadrants (200a, 200b, 200c and 200d), entry and exit of the queried entity in any one of the quadrant (200a, 200b, 200c and 200d), longevity of an entity in a particular quadrant for the particular period inputted by the end user (105).

The end user (105) may use any computing device such as a handheld computer, a notebook computer, a tablet computer, a personal computer, a laptop computer, a generic purpose computer, a specific purpose computer or any computing device that supports two way interactions with the investment decision making system (100) using graphical user interface.

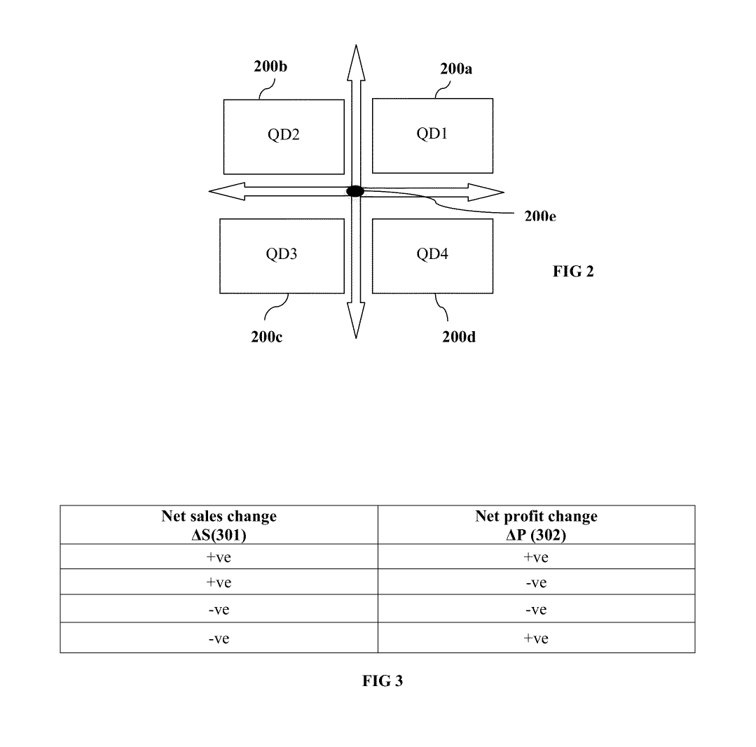

FIG. 2 and FIG. 3 illustrate a quadrant categorization functionality of the investment decision making system in accordance to one or more embodiment of the present invention. The investment decision making system (100) of the present invention places the entities in any one of the four quadrants (200a, 200b, 200c and 200d) of the 2×2 matrix based on relationship between two variables (i.e.) net profit change and net sales change for a given period inputted by the end user (105). The investment decision making system (100) of the present invention allocates the entity to various quadrants based on the relative movement of net profit change (ΔP) and net sales change (ΔS).

Here, the investment decision making system (100) calculates net profit change (ΔP) and net sales change (ΔS) as shown below:

Net Profit Change(ΔP)=P(n)−P(n−1);

Net Sales Change(ΔS)=S(n)−S(n−1);

Wherein P(n) is the net profit of an entity for period ‘n’ and P(n−1) is a net profit of an entity for a period (n−1) obtained from the database server (102) on real time basis. S(n) is the net sales of an entity for a period ‘n’ and S(n−1) is the net sales of an entity for a period ‘n−1’ obtained from the database server (102) on a real time basis.

The investment decision making system (100) of the present invention allocates a given entity (as shown in FIG. 2) to any one of the quadrants (200a, 200b, 200c or 200d) based on the relationship between two variables net profit change (ΔP) and net sales change (ΔS) for a given period of time (as shown in FIG. 3). For instance, the investment decision making system (100) allocates a given entity to quadrant 1 (QD1) (200a) if the value of net profit change (ΔP) (302) is positive and value of net sales change (ΔS) (301) is positive, whereas the investment decision making system (100) allocates a given entity to quadrant 2 (QD2) (200b), if the value of net profit change (ΔP) (302) is negative and the value of net sales change (ΔS) (301) is positive. The investment decision making system (100) allocates a given entity to quadrant 3 (QD3) (200c), if value of net profit change (ΔP) is negative and the value of net sales change (ΔS) is negative; whereas the investment decision making system (100) allocates a given entity to quadrant 4 (QD4) (200d), if the value of net profit change (ΔP) is positive and the value of net sales change (ΔS) is negative. The investment decision making system (100) allocates a given entity to the center point (200e) (i.e) point of intersection of all the four quadrants, if none of the scenarios (as shown in FIG. 3) is satisfied.

The investment decision making system (100) represents the entity to be allocated to any one of the quadrants (200a, 200b, 200c or 200d) as Cn(QDi, a), wherein ‘C’ represents the entity, ‘n’ represents the period, ‘QDi’ represents any one of the quadrant QD1, QD2, QD3, QD4 and ‘a’ represents age.

Quadrant 1 (QD1) (200a) contains entities with variables showing vertical movement above center point (200e) and variable showing horizontal movement on right side of center point (200e).

Quadrant 2 (QD2) (200b) contains entities with variables showing vertical movement above center point (200e) and variable showing horizontal movement on left side of center point (200e).

Quadrant 3 (QD3) (200c) contains entities with variables showing vertical movement below center point (200e) and variable showing horizontal movement on left side of center point (200e).

Quadrant 4 (QD4) (200d) contains entities with variables showing vertical movement below center point (200e) and variable showing horizontal movement on right side of center point (200e).

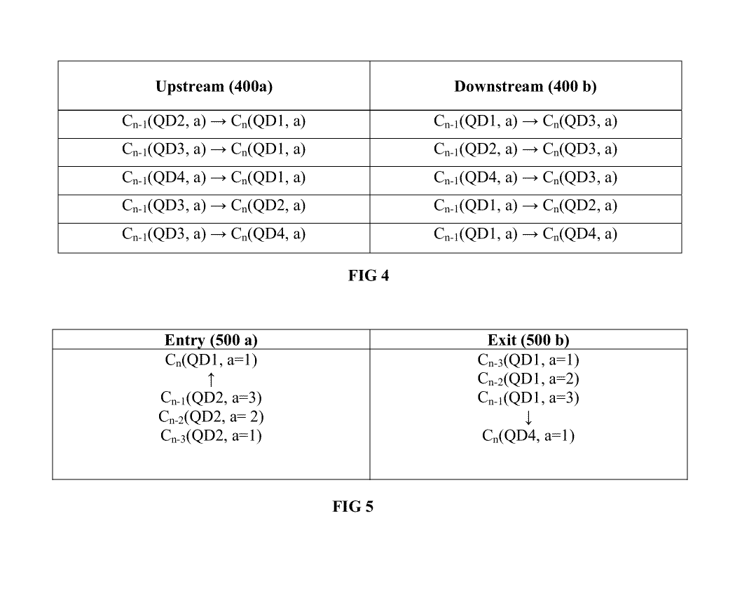

FIG. 4 illustrates an upstream and downstream movement of an entity in any one of the quadrant in accordance to one or more embodiment of the present invention. The investment decision making system (100) of the present invention also measures the changes in the operational performance of an entity, by monitoring the movement of the entities from one quadrant of the matrix to another quadrant. Upstream movement (400a) is the movement of an entity from a less desirable quadrant to a more desirable quadrant. Downstream movement (400b) is the movement of an entity from a more desirable quadrant to a less desirable quadrant.

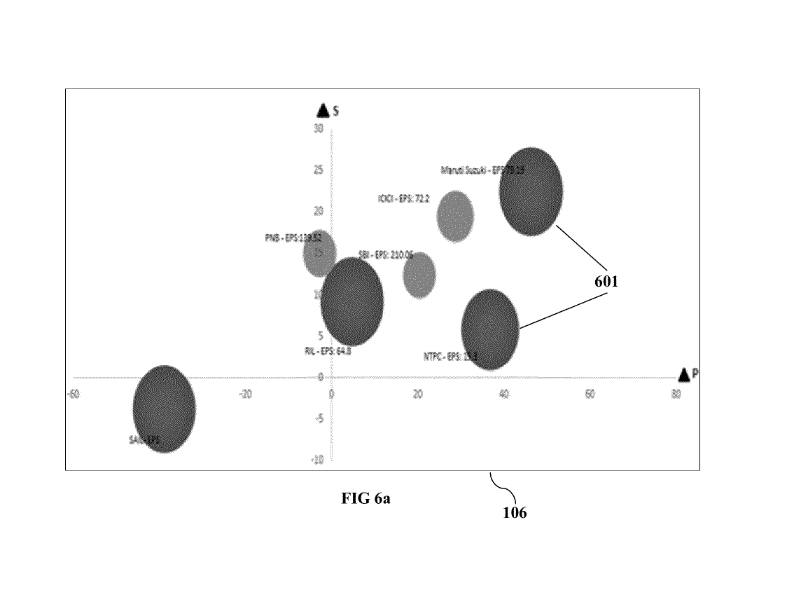

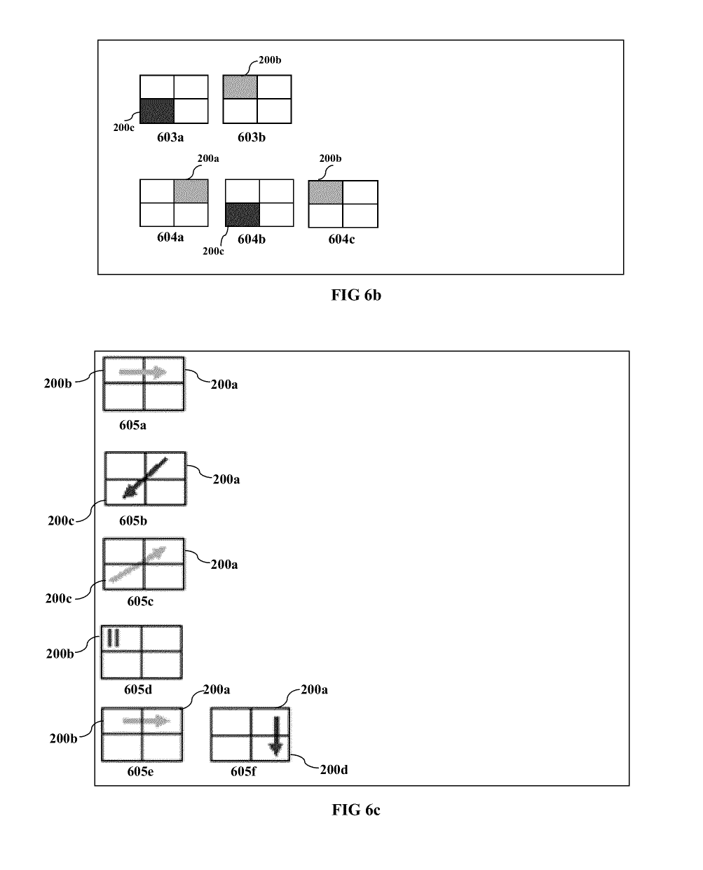

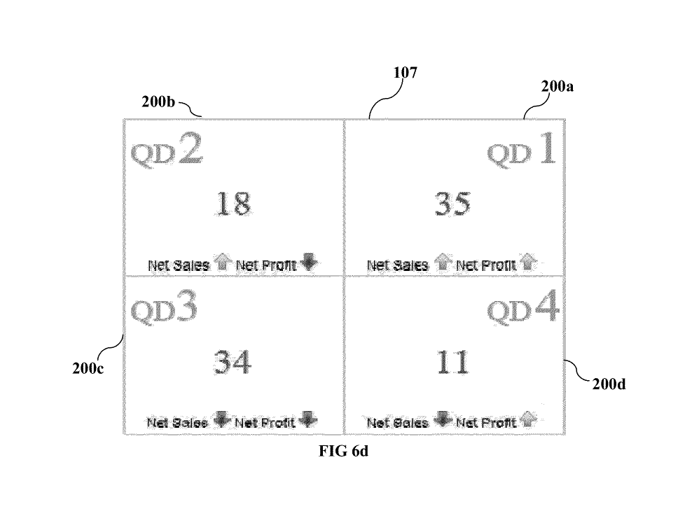

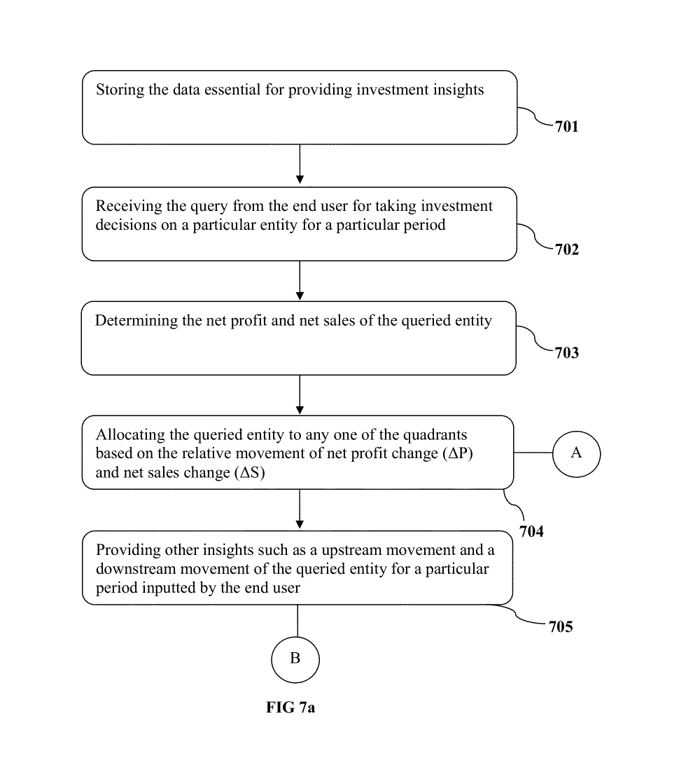

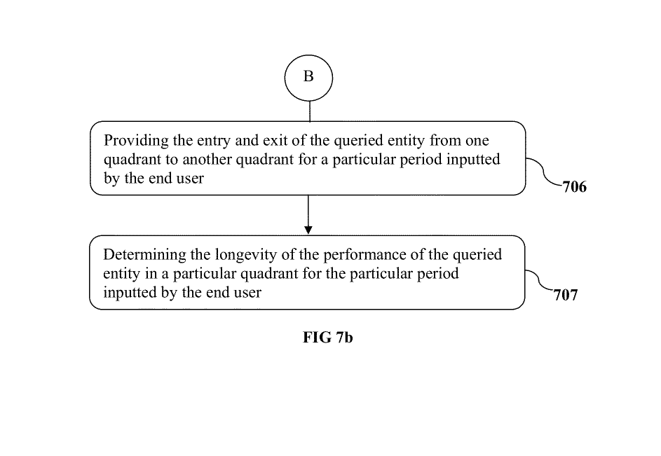

In accordance to one or more embodiment of the present invention, QD1 is considered to be a most desirable quadrant for an entity considered to be doing well and QD3 is considered as not a desirable quadrant for an entity considered to be not doing well. As shown in the FIG. 4, movement of an entity from QD2 to QD1, QD3 to QD1, QD4 to QD1, QD3 to QD2 and QD3 to QD4 is considered as an upstream movement (400a) of the entity. Whereas movement of the entity from QD1 to QD3, QD2 to QD3, QD4 to QD3, QD1 to QD2 and QD1 to QD4 is considered as downstream movement (400b) of the entity. The investment decision making system (100) of the present invention also provides graphical representation of the movement of an entity from one quadrant to another quadrant (as shown in FIG. 6b and FIG. 6c).

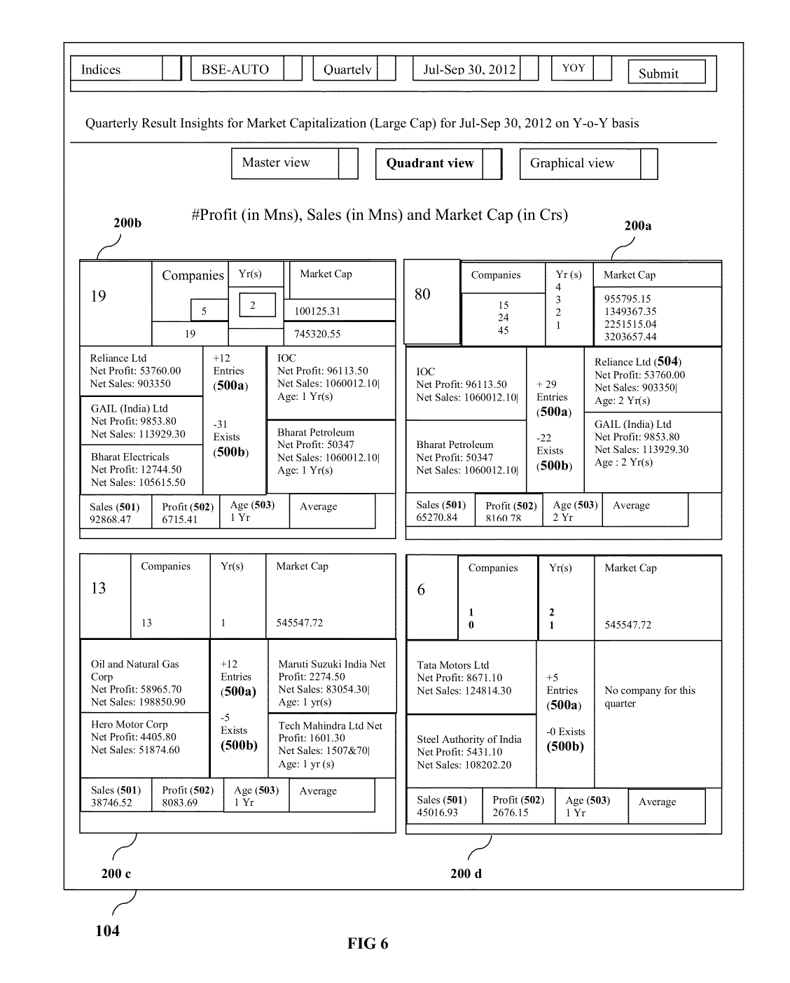

FIG. 5 illustrates the entry and exit of an entity in any one of the quadrant in accordance to one or more embodiment of the present invention. The investment decision making system (100) of the present invention also provides insight related to the entry (500a) and exit (500b) of the queried entity along the quadrants (200a, 200b, 200c, 200d) for a particular period inputted by the end user (105).

FIG. 6 illustrates an exemplary quadrant view of the investment decision making system in detail in accordance to one or more embodiment of the present invention. The investment decision making system (100) allocates the queried entity to any one of the quadrant (200a, 200b, 200c, 200d) based on net profit change (ΔP) and net sales change (ΔS) and provides a quadrant view (104) to end user (105). The investment decision making system (100) also determines the longevity of an entity in a particular quadrant measured in time periods (years, quarters, months, etc). The investment decision making system (100) also compares and determines relative performance of an entity in the same quadrant by using the age parameter, wherein age is the longevity of an entity in a particular quadrant measured in quarters. If there are multiple entities in the same quadrant then age is an important parameter to find relative ranking of entities in that quadrant for the particular period inputted by the end user (105). Further, the age parameter has different inference for each quadrant (200a, 200b, 200c and 200d) to determine longevity of the performance of an entity on net sales change (ΔS) and net profit change (ΔP) for the particular period inputted by the end user (105). For instance, higher the value of age for an entity in QD1 (200a) is most desirable, and higher the value of age in QD3 (200c) is least desirable quadrant. On the other end, zero or low age is desirable by an entity in QD3 (200c). The investment decision making system (100) also provides entries (500a) and exits (500b) of the queried entities along the quadrants (200a, 200b, 200c and 200d) for a particular period inputted by the end user (105) (as shown in FIG. 6).

The investment decision making system (100) provides cumulative net sales, net profit, age of entities, average sales (501), average profit (502), average age (503) of the entities in the quadrants (200a, 200b, 200c and 200d). For instance, the investment decision making system (100) displays the cumulative net sales of the entity Reliance (504) as 903350 millions, cumulative net profit of the entity Reliance (504) as 53760 million and age of the entity Reliance (504) as 2 years. Similarly the investment decision making system (100) provides the cumulative net sales, cumulative net profit and age of the queried entities present across the quadrants (200a, 200b, 200c and 200d). The investment decision making system (100) also provides top entrants and top exits by checking the movement of the entities from one quadrant to another quadrant along with the change in market valuations of the same, to the end user (105) (as shown in FIG. 6) in a matrix model so as to enable the end user (105) in taking an investment decision on a real time basis.

FIG. 6a illustrates a graphical representation of the entities in accordance to one or more embodiment of the present invention. The investment decision making system (100) of the present invention also provides on demand graphical view (106) of the entities depicted in the quadrants (200a, 200b, 200c, 200d) using different shapes, different sizes and different colors (as shown in FIG. 6a). The investment decision making system (100) is also configured to depict entities (601) in any shape such as a bubble, a star, a square or any other shape suitable to represent an entity and to fill the shapes in any desirable color such as a green, red or black. For instance, the entities that has resulted in a operating profit for the period inputted by the end user (105) may be depicted in green color, similarly entities that has resulted in operating loss for the period inputted by the end user (105) may be depicted in red color and entities that has resulted in operating profit of zero for the period inputted by the end user (105) may be depicted in black color. Here operating profit is the profit before tax excluding other income and exceptional items.

Operating profit=Profit before tax excluding other income and exceptional items

Also the size of the shape of the entity (601) (as shown in FIG. 6a) is a function of the absolute/modulus value of percentage of operating profit margin for the period inputted by the end user (105).

$$Operating profit margin = \frac{\begin{matrix}Profit before Tax \\ excluding other income \\ and exception item\end{matrix}}{Net Sales / Revenue} \times 100$$

The investment decision making system (100) of the present invention also provides other details such as name of the entity, current market price, earnings per share, growth in profits and growth in net sales/revenue of the entity on a cursor move by the end user (105) over the shape of the entity (601). Also the entities are positioned in any one of the quadrants based on the point of intersection of the entities net profit change (ΔP) and net sales change (ΔS) on the X and Y axis respectively.

FIG. 6b illustrates a graphical representation of the movement of an entity from one quadrant to another quadrant in accordance to one embodiment of the present invention. The investment decision system (100) of the present invention also provides graphical representation of the movement of an entity from one quadrant to another quadrant by placing two boxes (603a, 603b) or more boxes (604a, 604b, 604c) in a side by side configuration to an entity so as to provide cycle analysis. Here each such box (603a, 603b, 604a, 604b and 604c) represents position of a company in a specific quadrant (200a, 200b, 200c or 200d) based on change in net sales and net profit for the period inputted by the end user (105). For instance, two such boxes (603a, 603b) placed in a side by side configuration to the entity represent movement of an entity over two periods. As shown in FIG. 6b, the two boxes (603a, 603b) represent movement of an entity from quadrant 3 (200c) to quadrant 2 (200b). Also the quadrant 3 (200c) in the box (603a) may be filled up with a red color and quadrant 2 (200b) in the box (603b) may be filled up with a green color to represent the movement of an entity from a least desirable quadrant to a desirable quadrant. Similarly three such boxes (604a, 604b, 604c) placed in a side by side configuration to the entity represent movement of the entity over three periods (i.e.) movement of an entity from quadrant 1 (200a) to quadrant 3 (200c) and movement of an entity from quadrant 3 (200c) to quadrant 2 (200b). Also the quadrant 1 (200a) in the box (604a) may be filled up with a green color and quadrant 3 (200c) in the box (604b) may be filled up with a red color to represent movement of an entity from a most desirable quadrant to a least desirable quadrant. Similarly quadrant 2 (200b) in the box (604c) may be filled with a green color to represent movement of an entity from a least desirable quadrant (quadrant 3 in the box (604b)) to a desirable quadrant. Therefore, n such boxes may be placed in a side by side configuration to represent movement of the entity over ‘n’ periods.

FIG. 6c illustrates a graphical representation of the movement of an entity from one quadrant to another quadrant in accordance to another embodiment of the present invention. As shown in FIG. 6c, the investment decision making system (100) provides graphical representation of the movement of an entity from one quadrant to another quadrant by placing an arrow in a box to represent movement of an entity from one quadrant to another quadrant, so that only one box is placed in a side by side configuration to an entity to represent movement of an entity over two periods. Similarly two boxes are placed in a side by side configuration to an entity with an arrow to represent movement of an entity over three periods. Therefore n such boxes placed in a side by side configuration to an entity may represent movement of an entity over ‘n−1’ period. Also the color of the arrow used in such boxes is either red or green, wherein red color arrow used in the box represents downstream movement of an entity from one quadrant to another quadrant. The green color arrow used in such boxes represents upstream movement of an entity from one quadrant to another quadrant. For instance, a green color arrow may be placed in the box (605a) to represent upstream movement of an entity from quadrant 2 (200b) to quadrant 1 (200a) for a particular period inputted by the end user.

Similarly, the arrow in the box (605b) may be in red color to represent downstream movement of an entity from quadrant 1 (200a) to quadrant 3 (200c) for a particular period inputted by the end user. Similarly the arrow in the box (605c) may be of green color to represent upstream movement of an entity from quadrant 3 (200c) to quadrant 1 (200a). Also the two lines in the box (605d) shows paused movement of an entity in the quadrant 2 (200b) for the period inputted by the end user. Similarly boxes (605e) and (605f) shows movement of an entity from quadrant 2 (200b) to quadrant 1 (200a) and from quadrant 1 (200a) to quadrant 4 (200d) for the particular period inputted by the end user (105).

FIG. 6d illustrates a master view of the entities in accordance to one or more embodiment of the present invention. The investment decision making system (100) of the present invention also provides a master view (107) depicting the total number of entities present in a particular quadrant for a particular period inputted by the end user (105). For instance as shown in FIG. 6d, the numbers 35, 18, 34 and 11 represents the total number of entities present in each of the quadrant (200a, 200b, 200c and 200d) for a particular period inputted by the end user (105). Also arrows are placed near the net profit and net sales variables in each of the quadrant (200a, 200b, 200c and 200d) to represent increase/decrease of the net profit and net sales value of all the entities present in a particular quadrant (200a, 200b, 200c or 200d) for a particular period inputted by the end user (105). Further the arrow may be in green color with the arrowhead pointed upwards to represent the increase of net profit/net sales of all the entities present in a particular quadrant (200a, 200b, 200c or 200d) for a particular period inputted by the end user. Similarly the arrow may in red color with the arrowhead pointed downwards to represent the decrease of net profit/net sales of all the entities present in a particular quadrant (200a, 200b, 200c or 200d).

For instance, arrows filled with green color may be placed near the net sales variable and net profit variable with the arrowhead pointed upwards to represent the increase in net profit and increase net sales value of all the 35 entities present in quadrant 1 (QD1) (200a). Similarly a green color arrow with arrowhead pointed upward may be placed near the net sales variable to represent the increase in net sales of all the 18 entities present in quadrant 2 (QD2) (200b) and a red color arrow with the arrowhead pointed downward may be placed near the net profit variable to represent the decrease in net profit of all the 18 entities present in the quadrant 2 (QD2) (200b). Similarly a red color arrow with arrowhead pointed downwards may be placed near the net sales and net profit variables to represent the decrease in net profit and net sales of all the 34 entities present in the quadrant 3 (QD3) (200c). Similarly a red color arrow with arrowhead pointed downward may be placed near the net sales variable to represent the decrease in net sales of all the 11 entities present in quadrant 4 (QD4) (200d) and a green color arrow with the arrowhead pointed upward may be placed near the net profit variable to represent the increase in net profit of all the 11 entities present in the quadrant 4 (QD4) (200d).

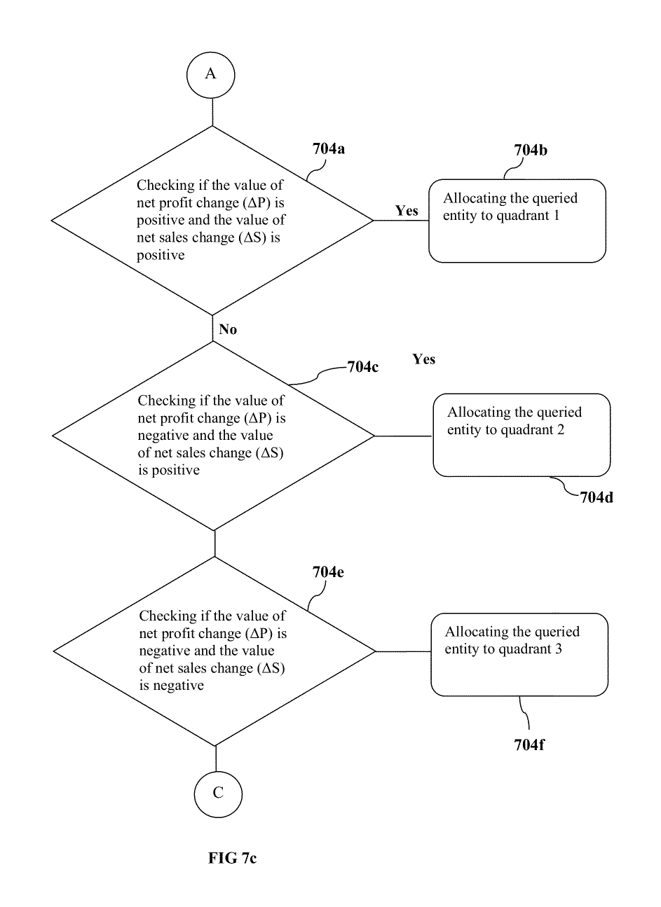

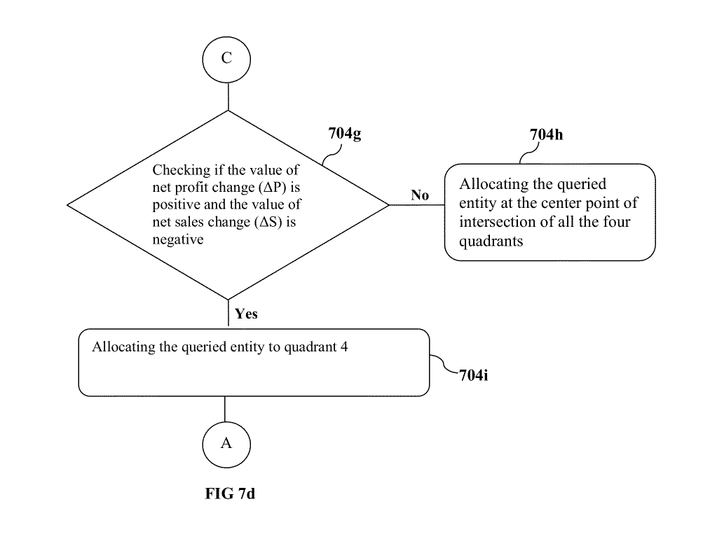

FIG. 7a and FIG. 7b illustrate a process flow of the method for providing investment insights in accordance to one or more embodiment of the present invention. The method for providing investment insights comprises the steps of storing the data essential for providing investment insights in step 701. Receiving the query from the end user for taking investment decisions on a particular entity for a particular period in step 702 and in step 703 determining the net profit and net sales for the queried entity. In step 704, allocating the queried entity to any one of the quadrants based on net profit change (ΔP) and net sales change (ΔS) using steps (704a-704i). The method of the present invention also provides other insights such as an upstream movement and a downstream movement of the queried entity for a particular period inputted by the end user in step 705. The method of the present invention provides the entry and exit of the queried entity from one quadrant to another quadrant for a particular period inputted by the end user in step 706, and also determines the longevity of the performance of the queried entity in a particular quadrant for the particular period inputted by the end user in step 707.

In accordance to one embodiment of the present invention, the method also provides on demand graphical view of the entities depicted in the quadrants using different shapes, different sizes and different colors.

In accordance to one embodiment of the present invention, the method also provides cumulative net sales of entities, cumulative net profit of entities, age of entities, average sales of the entities, average profit of the entities, average age of entities in a quadrant, entries and exits of entities from a quadrant, top entrants and top exits of entities from a quadrant, to the end user.

FIG. 7c and FIG. 7d illustrate a process flow of the method for allocating the queried entity to any one of the quadrants based on net profit change (ΔP) and net sales change (ΔS). The method for allocating the queried entity to any one of the quadrants based on net profit change (ΔP) and net sales change (ΔS) comprises the steps of checking if the value of net profit change (ΔP) is positive and the value of net sales change (ΔS) is positive in step 704a and allocating the queried entity to quadrant 1 (QD1) in step 704b. If the condition in step 704a holds false then checking if the value of net profit change (ΔP) is negative and the value of net sales change (ΔS) is positive in step 704c and allocating the queried entity to quadrant 2 (QD2) in step 704d. If the condition in step 704c holds false then checking if the value of net profit change (ΔP) is negative and the value of net sales change (ΔS) is negative in step 704e and allocating the queried entity to quadrant 3 (QD3) in step 704f; else checking if the value of net profit change (ΔP) is positive and the value of net sales change (ΔS) is negative in step 704g and allocating the queried entity to quadrant 4 (QD4) in step 704i. If the condition in step 704g holds false then allocating the queried entity at the center point of intersection of all the four quadrants in step 704h.

The investment decision making system (100) of the present invention allows the end user (105) to compare the net profit change (ΔP) and net sales change (ΔS) parameters of any entities across global markets. The investment decision making system (100) of the present invention also allows the end user (105) to filter the entities based on a particular index or an industry or a business group or from a particular market capitalization segment. The investment decision making system (100) also allows the end user to go for ‘all entities set’ and to choose random entities according to his choice for a particular period (quarterly or annually) for which the insights have to be generated.

The system of the present invention allows the user to compare the results on a year on year basis or a quarter on quarter basis or a month on month basis.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

We claim:

1. An investment decision making system (100) for providing investment insights comprising:
a) a database server (102) for storing the data (101) essential for providing investment insights;
b) an end user (105) for querying the investment decision making system (100) for deriving insights for any entity for a particular period inputted by the end user (105);
c) a processor (103) configured to:
i. determine a net profit change (ΔP) and a net sales change (ΔS) for the queried entity from the data (101) stored in the database server (102);
ii. allocate the queried entity to any one of the quadrant (200a, 200b, 200c, 200d) based on the relative movement of the net profit change (ΔP) and the net sales change (ΔS); and
iii. provide other insights for enabling the end user (105) to take investment decision such as a upstream movement, a downstream movement, entry and exit of the queried entity along the quadrants (200a, 200b, 200c, 200d) for a particular period inputted by the end user (105).

2. The investment decision making system (100) as claimed in claim 1, wherein the investment decision making system (100) is configured to:
a) calculate net profit change (ΔP) by subtracting the net profit of an entity for a period (n) from the net profit of an entity for a period (n−1) obtained from the database server (102); and
b) calculate net sales change (ΔS) by subtracting the net sales of an entity for a period (n) from the net sales of an entity for a period (n−1) obtained from the database server (102) on a real time basis.

3. The investment decision making system (100) as claimed in claim 2, wherein the period (n) is the particular period queried by the end user (105).

4. The investment decision making system (100) as claimed in claim 1, wherein the investment decision making system (100) allocates the queried entity to quadrant 1 (QD1) (200a) if the value of net profit change (ΔP) is positive and the value of net sales change (ΔS) is positive.

5. The investment decision making system (100) as claimed in claim 1, wherein the investment decision making system (100) allocates the queried entity to quadrant 2 (QD2) (200b) if the value of net profit change (ΔP) is negative and the value of net sales change (ΔS) is positive.

6. The investment decision making system (100) as claimed in claim 1, wherein the investment decision making system (100) allocates the queried entity to quadrant 3 (QD3) (200c) if the value of net profit change (ΔP) is negative and the value of net sales change (ΔS) is negative.

7. The investment decision making system (100) as claimed in claim 1, wherein the investment decision making system (100) allocates the queried entity to quadrant 4 (QD4) (200d) if the value of net profit change (ΔP) is positive and the value of net sales change (ΔS) is negative.

8. The investment decision making system (100) as claimed in claim 1, wherein:
a) the upstream movement is the movement of an entity from a less desirable quadrant to a more desirable quadrant; and
b) the downstream movement is the movement of an entity from a more desirable quadrant to a less desirable quadrant.

9. The investment decision making system (100) as claimed in claim 1, wherein the investment decision making system (100) also provides on demand graphical view (106) of the entities (601) depicted in the quadrants (200a, 200b, 200c, 200d) using different shapes, different sizes and different colors.

10. The investment decision making system (100) as claimed in claim 9, wherein the color of the said different shapes represents the operating profit of the entities.

11. The investment decision making system (100) as claimed in claim 9, wherein the size of the said different shapes is a function of the absolute/modulus value of the percentage of operating profit margin of the entities (601) for the particular period inputted by the end user (105).

12. The investment decision making system (100) as claimed in claim 8, wherein the investment decision making system (100) also provides graphical representation of the movement of an entity from one quadrant to another quadrant by placing two (603a, 603b) or more boxes (604a, 604b, 604c) in a side by side configuration to an entity so as to provide cycle analysis.

13. The investment decision making system (100) as claimed in claim 12, wherein each such box (603a, 603b, 604a, 604b, 604c) represents position of a company in a specific quadrant based on change in net sales and net profit for the particular period inputted by the end user (105).

14. The investment decision making system (100) as claimed in claim 8, wherein the investment decision making system (100) also provides graphical representation of the movement of an entity from one quadrant to another quadrant by placing an arrow in a box (605a, 605b, 605c, 605d, 605e or 605f) to represent movement of an entity from one quadrant to another quadrant.

15. The investment decision making system (100) as claimed in claim 9, wherein the investment decision making system (100) also provides other details such as name of the entity, current market price, earnings per share, growth in profits, growth in net sales/revenue of the entity on a cursor move by the end user over the shape of the entity (601).

16. The investment decision making system (100) as claimed in claim 1, wherein the investment decision making system (100) determines the longevity of the performance of the queried entity in a particular quadrant (200a, 200b, 200c, 200d) for a particular period inputted by the end user (105).

17. The investment decision making system (100) as claimed in claim 1, wherein the particular period is on a quarterly basis or a half yearly basis or a yearly basis.

18. The investment decision making system (100) as claimed in claim 1, wherein the investment decision making system (100) also provides cumulative net sales of entities, net profit of entities, age of entities, average sales of the entities, average profit of the entities, average age of entities in a quadrant, top entrants and top exits of the entities from a quadrant for a particular period inputted by the end user (105).

19. The investment decision making system (100) as claimed in claim 1, wherein the investment decision making system (100) also provides a master view (107) depicting the total number of entities present in a particular quadrant for a particular period inputted by the end user (105).

20. The investment decision making system (100) as claimed in claim 19, wherein the master view (107) also depict the increase/decrease in net sales and net profit of all the entities present in a particular quadrant for a particular period inputted by the end user (105).

21. A method for providing investment insights comprising the steps of:
a) storing the data essential for providing investment insights;
b) receiving the query from the end user for taking investment decisions on a particular entity for a particular period inputted by the end user;
c) determining the net profit, net sales for the queried entity;
d) allocating the queried entity to any one of the quadrants based on the relative movement of net profit change (ΔP) and net sales change (ΔS);
e) providing other insights such as a upstream movement and a downstream movement of the queried entity for a particular period inputted by the end user;
f) providing the entry and exit of the queried entity from one quadrant to another quadrant for a particular period inputted by the end user; and
g) determining the longevity of the performance of the queried entity in a particular quadrant for the particular period inputted by the end user.

22. The method as claimed in claim 21, wherein allocating the queried entity to any one of the quadrants based on net profit change (ΔP) and net sales change (ΔS) comprises the steps of:
a) checking if the value of net profit change (ΔP) is positive and the value of net sales change (ΔS) is positive and allocating the queried entity to quadrant 1 (QD1); else
b) checking if the value of net profit change (ΔP) is negative and the value of net sales change (ΔS) is positive and allocating the queried entity to quadrant 2 (QD2); else
c) checking if the value of net profit change (ΔP) is negative and the value of net sales change (ΔS) is negative and allocating the queried entity to quadrant 3 (QD3); else
d) checking if the value of net profit change (ΔP) is positive and the value of net sales change (ΔS) is negative and allocating the queried entity to quadrant 4 (QD4); else
e) allocating the queried entity at the center point of intersection of all the four quadrants.

23. The method as claimed in claim 21, wherein the method also provides cumulative net sales of entities, cumulative net profit of entities, age of entities, average sales of the entities, average profit of the entities, average age of entities in a quadrant, entries and exits of entities from a quadrant, top entrants and top exits of entities from a quadrant to the end user.

24. The method as claimed in claim 21, wherein the method also provides on demand graphical view of the entities depicted in the quadrants using different shapes, different sizes and different colors.
